(19) United States
(12) Patent Application Publication
(10) Pub. No.: US 2022/0067444 A1
(43) Pub. Date: Mar. 3, 2022

(54) Microscopy System and Method for Monitoring a Learning Process of a Machine Learning Model

(71) Applicant: Carl Zeiss Microscopy GmbH, Jena (DE)

(72) Inventors: Manuel Amthor, Jena (DE); Daniel Haase, Zöllnitz (DE)

(21) Appl. No.: 17/462,234

(22) Filed: Aug. 31, 2021

(30) Foreign Application Priority Data
Sep. 2, 2020 (DE) 10 2020 122 980.1

(51) Int. Cl. G06K 9/62; G02B 21/36; G06N 3/08

(52) U.S. Cl. CPC G06K 9/6262; G06N 3/088; G02B 21/367

(57) ABSTRACT

A microscopy system and a method for monitoring a learning process of a machine learning model are described. The microscopy system comprises a microscope with a camera for capturing a microscope image and a computing device. The computing device processes the microscope image by means of a machine learning model. A learning process of the machine learning model is conducted with a training system. In the learning process, model parameter values of the machine learning model are adjusted using training data. During the learning process, a quality measure based on the training data and a quality measure based on validation data are calculated for respectively current model parameter values. A training learning progression and a validation learning progression are formed from the quality measures The training system comprises a verification model, which is fed with the training learning progression and validation learning progression during the learning process. The verification model is designed to generate a quality assessment of the learning process depending on the training learning progression and validation learning progression.

### REFERENCE TO RELATED APPLICATIONS

The current application claims the benefit of German Patent Application No. 10 2020 122 980.1, filed on 2 Sep. 2020, which is hereby incorporated by reference.

### FIELD OF THE DISCLOSURE

The present disclosure relates to a microscopy system that uses a machine learning model. Model parameter values of the machine learning model are defined in a learning process. The disclosure further generally relates to a method for monitoring a learning process (training progression) of a machine learning model, in particular for microscopes or other measurement or image processing devices.

### BACKGROUND OF THE DISCLOSURE

Machine learning models and in particular deep learning methods are playing an increasingly important role in product development, in particular in the development of microscopes. For example, modern microscopes use machine learning models to process an overview image automatically for the navigation of a sample. Regions of interest, sample receptacles/vessels and sample carriers can be identified in the overview image by means of segmentation, classification and detection methods. This enables an automated further processing or a precise navigation, for example, by having a sample stage adjustment occur as a function of the processed overview image.

Unlike traditional algorithms, machine learning models require a sufficiently large amount of representative training data based on which a process or processing step is learned. Additional data is generally collected as training data over time, for example in order to cover further applications, to improve precision or to take into account changed boundary conditions. For instance, the sample carriers typically provided for microscopes can change. In such cases, it is generally necessary to conduct a new training of the machine learning model. A new training of the machine learning model is accordingly often necessary for rapid product improvements. Moreover, a plurality of neural networks are typically used for complex tasks, for example finding a sample in a microscope overview image. The number of training processes that are continuously required is thus high and is expected to rise in the future.

A machine learning expert is currently required to monitor or verify these training processes manually. As explained in greater detail later on, the task of the machine learning expert is to detect several indicators of errors. These include, for example, an overfitting of the machine learning model to training data, a data bias (i.e. an overrepresentation of a class within the training data), a poor convergence behaviour of the model parameter adjustment, sudden jumps in the error function during the training process or an insufficient representativeness of validation data or training data in terms of the breadth of occurring features. Generally atypical training processes also provide the machine learning expert with clues as to whether boundary conditions of the training process should be modified. A quality measure which is automatically output in the training process, for example the percentage of provided training and validation data correctly classified by a classification model, is insufficient alone. This is due to the fact that, for example, it is only possible to evaluate the generalization of the machine learning model to unseen data based on the progression of a quality measure during the training and not alone by the quality measure at completion of the training.

Possible progressions of a quality measure during learning processes of a machine learning model are described in the following with reference to the attached figures; first, however, a learning process will be outlined in greater detail. Model parameter values of the machine learning model are adjusted continuously in the learning process based on provided training data. The model parameter values are modified in each iterative pass, which can also be called an epoch or which may be a part of an epoch. A quality measure is respectively calculated for the model parameter values during this process. For example, in the case of a supervised learning process, in which the target data (respectively one or more labels) for the training data is given/predetermined, the extent to which an output of the machine learning model matches the target data can be determined as a quality measure. An example is the classification of a microscope image according to potential objects, e.g. different sample carrier types such as multiwell plates, chamber slides and Petri dishes. A quality measure relating to the training data is calculated in each epoch, for example the percentage of correct classifications (accuracy/correct classification rate). Validation data, which can be taken from the same data set or the same statistical distribution as the training data, is also provided. The validation data is not used directly for adjusting the model parameter values. Rather, a quality measure is calculated for the model parameter values in each epoch based on the validation data, for example the percentage of correct classifications of the validation data. FIGS. 1 to 6 respectively show a graph of a training learning progression 1, which is formed from the quality measures calculated for respectively current model parameter values based on the training data and which can also be called a quality measure progression specific for the training data. FIGS. 1 to 6 also respectively show a graph of a validation learning progression 2, which is formed from the quality measures calculated for respectively current model parameter values based on the validation data and which can also be called a quality measure progression specific for the validation data. The horizontal axis t in FIGS. 1 to 6 indicates the experience, number of epochs or time of the learning process. The vertical axis Q indicates the quality measure. FIGS. 1 to 4 show learning processes that a machine learning expert would classify as inadequate or deficient. A final value of the validation learning progression 2 towards the end of the learning process is low in all four cases. The reasons for these negative results are different and cannot be appreciated from the final value alone, but rather only from the course of the validation learning progression 2 and the training learning progression 1. For example, there may be an overfitting when the quality of the training learning progression 1 rises with ongoing training while, in contrast, the validation learning progression 2 only rises initially and then falls or tapers off. This could be the cause of the drop in the validation learning progression 2 in the example depicted in FIG. 1.

FIG. 2 shows final values for the quality measures similar to those of FIG. 1, but for different reasons. In FIG. 2, the high quality of the training learning progression 1 and the consistently low quality of the validation learning progression 2 may indicate that the training data is under representative, i.e. it is not possible for the model to learn to cover the large bandwidth of the validation data from the limited training data.

In FIG. 3, the initially higher quality of the validation learning progression 2 vis-à-vis the training learning progression 1 may indicate that the validation data is not representative and that it is easier for the machine learning model to learn features that occur in both data sets as opposed to features that occur in the training data alone.

FIGS. 5 and 6, on the other hand, show desired progressions of the training learning progression 1 and validation learning progression 2. Both curves rise continuously in these figures, while the quality based on the training data is only moderately better than the quality based on the validation data over the learning process. The initial fluctuations in FIG. 5 depend on the learning rate. The learning rate indicates the magnitude by which model parameter values are modified from one epoch to the next. A high learning rate can generally lead to a faster iterative adjustment of the model parameter values; however, an optimal set of values of the model parameters can also be skipped as a result of a high learning rate, whereby the quality varies or fluctuates with an increasing number of epochs. Identifying suitable modifications of a learning process from the graphs of the learning progressions requires a considerable amount of time and extensive experience on the part of a machine learning expert.

A generic method for monitoring or supervising a learning process of a machine learning model comprises an initiation and running of a learning process using training data in order to adjust model parameter values of the machine learning model. During the learning process, a quality measure based on the training data and a quality measure based on validation data are calculated for respectively current model parameter values. A training learning progression and a validation learning progression are formed from the quality measures, for example as described above with reference to FIGS. 1 to 6.

A generic microscopy system includes at least one microscope, which comprises at least one camera for capturing a microscope image and a computing device. The computing device comprises an image processing program for processing the microscope image by means of a machine learning model. The microscopy system further includes a training system for running a learning process of the machine learning model, wherein model parameter values of the machine learning model are adjusted in the learning process using training data.

A similar approach can also be adopted with a machine learning model comprising a generative adversarial network (GAN). Such a network comprises at least one generator and one discriminator. The generator generates an output from random data/noise. The discriminator is trained to be able to differentiate the output of the generator from predetermined training data. The generator, on the other hand, is trained to generate outputs which the discriminator is ideally unable to differentiate from the training data. In relation to GANs, a generic method for monitoring a learning process of a machine learning model containing a GAN comprises that a learning process is initiated using training data in order to adjust model parameter values of the machine learning model, wherein at least one quality measure is calculated during the learning process for respectively current model parameter values and at least one training learning progression is formed from the quality measures.

To reduce the dependence on machine learning experts, automation methods such as, for example, hyperparameter tuning are known. Hyperparameters are parameters of the machine learning model that are not updated during the learning process, but rather relate, for example, to the learning rate of a gradient descent method or the network architecture, e.g. the number or size of the layers of a convolutional neural network (CNN). In simple implementations, different hyperparameter values are successively randomly tested and subsequently evaluated. It is more efficient, however, to begin by conducting a training process with starting values for the hyperparameters. In this case, an assessment criterion to be defined, for example prediction precision based on validation or test data, is used to determine a modification of the hyperparameter values (e.g. by means of Bayesian optimization) and a new training process is conducted.

A similar approach is adopted with AutoML, a software package for automating the machine learning process. Different network architectures and hyperparameters are automatically tested and a simple quality measure is output as an assessment, for example the success rate determined for test data in the case of a classification. Alternatively, an expert can look at the curves of the training and validation learning progressions described in the foregoing and perform a manual evaluation.

It can be considered an object of the invention to provide a microscopy system, a method and a computer program for monitoring a learning process of a machine learning model which allow the learning process of the machine learning model to be conducted in a manner that is as efficient, as fast and as reliable as possible.

### SUMMARY OF THE DISCLOSURE

This object is achieved by means of the microscopy system with the features of claim 1, by means of the methods with the features of claim 2 or 18 and by means of the computer program of claim 19.

According to the invention, in the method of the aforementioned type, the training learning progression and the validation learning progression are fed to a verification model during the learning process. The verification model generates a quality assessment (quality rating) of the learning process of the machine learning model depending on the training learning progression and the validation learning progression.

The computer program of the invention comprises commands that cause the execution of the method according to the invention when said method is executed by a computer.

According to the invention, the training system in the microscopy system of the aforementioned type comprises a verification model that is fed with the training learning progression and the validation learning progression during the learning process. The training learning progression indicates a quality measure for respectively current model parameter values based on the training data. The validation learning progression indicates a quality measure for respectively current model parameter values based on validation data. The verification model is designed to generate a quality assessment of the learning process of the machine learning model depending on the training learning progression and the validation learning progression.

The invention thus does not use the quality measure at the completion of the training alone for the assessment of the learning process, but rather the progressions, in particular qualitative or quantitative changes in quality over the epochs of the training. The verification model is thereby able to make more precise statements regarding the learning process than a simple statement regarding precision based on test data. In particular, it is possible to assess the training/validation learning progressions before the completion of a training process, whereby a training process that has been assessed as poor does not have to be completed but rather can be modified while still in progress or re-initiated with modified settings. The invention thus enables an acceleration of the entire learning process. Required interventions by a machine learning expert are reduced or eliminated entirely. The expression “training/validation learning progressions” is used as a short form of: “training learning progression and validation learning progression”.

For the sake of clarity, it is noted here that known methods such as hyperparameter tuning or AutoML add additional optimization loops by means of which other parameters (hyperparameters or different network architectures) are optimized. A simple quality measure is used as assessment criterion for these optimizations, not the progression described here. These known methods are not concerned with the question of how a training process per se can be evaluated efficiently and meaningfully.

According to the invention, it is provided in a method of the aforementioned type for monitoring a learning process of a machine learning model containing a generative adversarial network (GAN) that the at least one training learning progression is fed to a verification model during the learning process. The verification model generates a quality assessment of the learning process of the machine learning model depending on the at least one training learning progression.

### Optional Embodiments

Advantageous variants of the microscopy system, method and computer program according to the invention are the object of the dependent claims and will be explained in the following description.

The training learning progression and the validation learning progression can be fed to the verification model during the ongoing training of the machine learning model before a predetermined stopping criterion has been reached and/or occur during still further iterations or epochs of the training. Conventional assessments of a learning process assess quality after completion of the training or require a manual intervention of a machine learning expert. In contrast, an assessment according to the present invention with optional follow-up actions can occur before a predetermined stopping criterion is reached. The stopping criterion can be, for example, a maximum number of epochs, a convergence criterion and/or a threshold value of the quality measure.

It can thus be decided based on the quality assessment whether to continue the ongoing training of the machine learning model, in particular until a predetermined stopping criterion is reached, or whether to abort the ongoing training. It is thereby avoided that an ongoing training process that is not expected to provide a good fitting of the model parameter values is continued for an unnecessarily long time. Rather, a re-initiation of the training with modified model parameters can occur or a machine learning expert can be consulted early on to carry out a manual correction.

### Modification of Training Parameters

The quality assessment output by the verification model can also comprise a suggestion for the modification of training parameters, in particular for a modification during the ongoing learning process/training process or for a new learning process to be initiated. Training parameters can denote hyperparameters or model parameters to be adjusted/modified. For example, the modification of training parameters can comprise a modification of a learning rate and/or a modification of a set number of epochs after which a training process should end at the latest. By reducing the number of epochs, it is possible, for example, to avoid an overfitting of the machine learning model. It may be expedient to increase the number of epochs when the training/validation learning progressions are assessed as good, but no saturation or convergence towards a certain quality measure is apparent in the learning progressions. A number of epochs can be modified during the ongoing learning process or for a new learning process to be initiated. It can be expedient to modify the learning rate, for example, in cases where the quality assessment assumes or determines a local optimum of the model parameter values. A local optimum means that, based on the current model parameter values, both raising and reducing the model parameter values leads to worse results, but that there are nevertheless model parameter values that achieve a better quality (global optimum). Modifying the learning rate can comprise a unique or repeated increase of a learning rate to break out of the local optimum of model parameter values. The learning rate can then be reduced again. A local optimum can be identified in the progression of the quality values, for example, by the convergence of the progression towards a threshold value that lies below a predetermined (quality) threshold. The convergence indicates that an optimum has been found while the low quality indicates that the optimum may only be a local optimum.

### Verification Machine Learning Model

The verification model can comprise or be a machine learning model (verification machine learning model in the following) trained to generate the quality assessment as an output from at least the training learning progression and the validation learning progression as input data.

In terms of its architecture and design, the verification machine learning model is independent of the machine learning model whose learning process is to be verified. The verification machine learning model can be used in particular to verify a plurality of different machine learning models.

The verification machine learning model can be trained or have been trained by means of an unsupervised learning process. In an unsupervised learning process, a plurality of training learning progressions and associated validation learning progressions without manual annotation are used as training data (verification machine learning model training data). The model performs a clustering in which the training data is clustered into at least two groups, which can correspond to a good and a bad quality assessment. Other classifications are also possible.

Alternatively, the verification machine learning model can be trained or have been trained by means of a supervised learning process. In a supervised learning process, a plurality of training learning progressions and associated validation learning progressions with a respective quality assessment are used as verification machine learning model training data. The predetermined quality assessments can be provided, for example, by a machine learning expert and constitute either a binary classification or a continuous value. In the training, the predetermined quality assessments are used as target data and model parameters of the verification machine learning model are fitted so that the verification machine learning model generates an output that comes as close as possible to the target data. In the case of a continuous quality measure, a regression method can be implemented.

An RNN (recurrent neural network) can form the verification machine learning model or be comprised by the same. Unlike simple neural networks, an RNN comprises feedback neural connections in addition to feedforward neural connections. An RNN is particularly suitable when the training learning progression and the validation learning progression are each fed to the verification machine learning model as a sequence of quality measure values. These data sequences are also called time series. The inputs of the RNN thus comprise the two time series. An example of an RNN is a LSTM-RNN (long short-term memory RNN) designed for sequence classification.

Alternatively, a CNN (convolutional neural network) can form the verification machine learning model or be comprised by the same. A CNN is particularly suitable when the input data comprises one or more 2D matrices or images. In this case, the training learning progression and the validation learning progression can be fed to the verification machine learning model as graphs (plots) in the form of image data. The verification machine learning model can also comprise different neural networks, which are used sequentially, in parallel or alternatively. It is also possible to implement an RNN and a CNN, in particular as described in the foregoing. The results of both networks can be compared with each other for verification purposes in this case. Depending on the input data, it is also possible for cases to occur in which only one of the two networks provides a reliable and precise assessment.

In principle, the input data for the verification machine learning model can take any form. For example, numerical data in text form or also image data (training plots of quality measures) are possible. What is relevant here is that the input data contain a progression of the quality measures. The input data can also be or comprise log data that is generated and saved in the training process. The log data respectively contains a quality measure for the successive epochs, for example a loss/gain value, which denotes a deviation of current output data from target data based on a used loss function. The log data can contain further information that is either not considered by the verification machine learning model or is alternatively taken into account in the form of contextual data, as will be described in greater detail later on.

### Anomaly Detection

The verification machine learning model can also generate an output specifying whether an anomaly was detected, i.e. a deviation from typical training progressions, as a quality assessment. The verification machine learning model can in particular comprise an autoencoder for the anomaly detection. An autoencoder is a neural network trained to generate an output that matches the input as closely as possible. To this end, for example, a loss function can be used in the training that measures an error between current output and input. The loss function is then minimized. The autoencoder can be trained or have already been trained with specific training learning progressions and validation learning progressions that do not contain any anomalies. The autoencoder thereby learns to replicate an input precisely when said input lies within a statistical distribution of its training data (which did not contain any anomalies). If the autoencoder is unable to replicate an input training learning progression and validation learning progression adequately, an anomaly can be inferred. The anomaly detection can be output as the quality assessment or output in addition to the illustrative embodiments of the quality assessment outlined in the foregoing.

### Modification of Training Parameters by the Verification Machine Learning Model

The quality assessment can comprise a modification of training parameters involving a modification of the model parameter values. The verification machine learning model thus also receives as inputs, in addition to the training learning progression and the validation learning progression, the current model parameter values and optionally also past model parameter values implemented during the learning process up to that point. The verification machine learning model generates a function to determine a set of modified model parameter values therefrom.

In particular, the verification machine learning model can comprise a neural network that is trained by a supervised training process. Training data for the neural network comprises a plurality of training learning progressions as well as associated validation learning progressions and model parameter values. Modifications of the model parameter values are specified as target data. For the sake of clarity, it is emphasized here that the training/validation learning progressions used as training data are not derived from a training of the verification machine learning model, but rather from a training of one or more reference machine learning models. The type of reference machine learning model used is in principle irrelevant; however, they should be as similar as possible to the machine learning model to be verified and can also be identical to the same.

The verification machine learning model can also comprise a neural network trained by a generally known reinforcement learning method. In this case, a so-called reinforcement learning agent, i.e. a decision function, learns in a defined training environment/simulation environment, for an input comprising a training learning progression, a validation learning progression and associated model parameter values, how to modify the model parameter values in order to optimize a quality assessment. In the learning phase, the agent tries out different parameters and receives the training/validation learning progressions as well as an assessment of the finally determined model parameters as input. The relationship between training/validation learning progressions and improved model parameter values can be learned in this manner.

### Contextual Data

The verification model can optionally be designed to define assessment criteria for generating the quality assessment depending on contextual data relating to the machine learning model or the training of the machine learning model. The contextual data is predefined and received together with the training/validation learning progressions. It is thus taken into account that a desired training/validation learning progression and error characteristics typically occurring in training/validation learning progressions depend on the architecture or training method of the machine learning model to be supervised. For example, transient oscillations in the progressions of the quality measure are a sign of a desired progression for some applications, but are less pronounced or hardly occur at all in other applications.

In particular, the contextual data can be information regarding one more of the following aspects:

A type of a learning method with which the training of the machine learning model is conducted. It is possible to distinguish between at least between two or more of the following: supervised training, unsupervised training, reinforcement learning and a use of adversarial networks (adversarial training).

A type of a task of the machine learning model. In this connection, it is possible to distinguish between at least two or more of classification, segmentation, detection or regression.

An architecture of the machine learning model. Backbone networks, e.g. ResNet, and VGG have different learning behaviours so that a desired training/validation learning progression differs between these architectures. VGG is a specific architecture of a CNN for image recognition. ResNet denotes a residual neural network, which gets its name from the fact that the outputs of some neurons skip the next layer and are used directly as inputs of a later layer. Convergence behaviours also differ for different implementations of the required task, e.g. DeepLab and FCN (fully convolutional network) have different convergence behaviours.

Values of hyperparameters of the machine learning model. The hyperparameters can include in particular a learning rate or a learning rate progression, a momentum or a regulation parameter of the optimization function (loss/gain function) used.

A type of training/validation data, e.g. a data type or data characteristics such as image size; classification according to image data, audio data or video data; class distributions in the case of a classification and segmentation.

It is thus possible to input the aforementioned contextual data for the training of the verification machine learning model. This allows the verification machine learning model to learn a relationship between the contextual data and target data.

### Verification Algorithm

The verification model can also comprise, instead of or in addition to the verification machine learning model, a classic algorithm without a machine learning model for processing and assessing the training/validation learning progressions.

In particular in the case of a classic algorithm, one or more of the following factors can be taken into account for the quality assessment:

Jumps in the training learning progression or validation learning progression.

Number of epochs as of which a convergence or saturation of a value of the quality measures occurs, and the value of the quality measures as of saturation. Saturation can be understood in this context as a rate of change of the quality measure that is lower than a predetermined limit value. A saturation at a low/poor quality measure can indicate, for example, a local optimum of the model parameter values, as described in the foregoing.

Difference between the training learning progression and the validation learning progression. A difference that is persistently greater than a limit value can indicate an overfitting or an underfitting of the model parameter values. If the quality of the validation learning progression is persistently higher than that of the training learning progression, the training or validation data may be unrepresentative.

Divergence of the training learning progression or validation learning progression.

Initial fluctuations in the training learning progression and validation learning progression and subsequent monotonous (rising) training learning progression and validation learning progression. Initial fluctuations occur with sufficiently high learning rates. If no fluctuations are detected, it can be provided, in the event of a re-initiation of the training process, to select a higher learning rate or another regularization, for example to switch an L1 or L2 regularization of an objective function, wherein a penalty term is added as an absolute sum or squared sum of the model parameter values to be learned, or to modify the value of a regularization constant which is multiplied by said absolute sum or squared sum.

Early achievement of an optimum of the model parameter values at a quality measure that indicates a quality that is poorer than a predetermined limit value. “Early” can be defined as a number of epochs that is lower than a predetermined number. An optimum can be defined as a constant or saturated value of the quality in the training learning progression and/or validation learning progression. Such an early achievement of an optimum can also be called a “sharp optimum”. Even if the value of the quality measure is not conspicuous or poor per se, such a sharp optimum indicates poor generalization characteristics. This results in a poor performance of the machine learning model when confronted with previously unseen cases.

### Prediction of the Training/Validation Learning Progressions

In order to already be able to make an assessment or estimate the further training progression at an early stage of the ongoing learning process, it can be provided that a prediction regarding the further course of the training/validation learning progressions is made. To this end, the training learning progression and the validation learning progression (so far) are input into a prediction machine learning model. The prediction machine learning model is trained to predict a future/further progression of an input training learning progression and a further progression of an input validation learning progression from said input training learning progression and validation learning progression. The prediction machine learning model may in particular add the predicted further progressions onto said input training learning progression and validation learning progression. The prediction machine learning model is trained with training data comprising a beginning of training/validation learning progressions as inputs and the complete or subsequent training/validation learning progressions as target variables.

The training/validation learning progressions supplemented by the prediction can be output to a user or to the verification model. The prediction can thus be used to abort a learning process early, to re-initiate a learning process with different settings or to influence a learning process. In principle, the prediction can occur before, at the same time as or after the assessment procedure carried out by the verification model. It can further be estimated based on the prediction whether it is preferable to re-initiate the training or whether modifications of the parameters in the current training step are worthwhile.

### Generative Adversarial Network

The optional features described herein can also be used for the method of the invention that relates to a generative adversarial network (GAN). In this case, the described optional features need to be modified such that the training/validation learning progressions are replaced by at least one training learning progression. With a GAN, it is not necessary to use validation data so that it is also not necessary to generate a validation learning progression. Training data is used with a GAN in particular for the discriminator, which is to learn to be able to differentiate the training data from the outputs of the generator. The discriminator can be trained, for example, with an objective function that awards penalty points when training data is mistaken for outputs of the generator or when outputs of the generator are mistaken for training data. An expression used in the objective function of the discriminator can comprise the objective or loss function for the generator, whereby the generator can also be trained indirectly via the discriminator. For example, the aforementioned penalty points, in more general terms a discriminator loss (result of the loss function of the discriminator), can serve as a quality measure with a GAN. Possible metrics for the determination of the quality measure are in particular: loss of the generator and/or discriminator, a recognition rate of the discriminator for real images and/or for images generated by the generator, an adversarial loss, reconstruction loss, content loss, perceptual loss or cycle consistency loss. Depending on the metrics selected, the objective function is minimized, maximized or optimized by a minimax/maximin rule. Since the discriminator and generator work against each other, the captured quality measure will typically not converge towards an upper or lower limit in the event of a successful training, in contrast to other machine learning models. Conclusions regarding whether the training seems to be working or should be aborted or modified can nevertheless be drawn from a progression of the quality measure. In principle, in order to attain advantages of the invention, the evaluation of a single quality measure progression is sufficient by itself. It is also possible to capture two or more quality measures and to evaluate their progressions, for example a generator loss and a discriminator loss, which can also contain the expression of the generator loss. Alternatively or additionally, it is also possible to determine a quality measure for a training learning progression that does not result from an objective function optimized for the determination of the model parameters. For example, it can occur that a GAN is re-trained repeatedly whenever new training data arises, for example when new microscope images of novel sample carriers or support frames for sample carriers are introduced. In these cases, it is possible to determine as a further quality measure, for example, an accuracy with which the outputs generated by the generator to be trained are recognized by a discriminator of a GAN that is already ready trained with older training data. Further quality measures can relate to the variety of the outputs generated by the generator, i.e. whether a distribution of its outputs is as extensive as a distribution of the training data. The concept of a GAN in the present context can comprise all variants of the same, for example also a Wasserstein GAN or variants in which a regression model is used instead of a discriminator that carries out a classification. A microscopy system of the invention can comprise a computing device for carrying out the described method variants with a GAN.

### General Features

The machine learning model to be monitored can be designed in any manner provided that model parameter values are adjusted iteratively and, in the process, a quality measure for the respectively current model parameter values is output or can be determined. The machine learning model can be based on, for example, a neural network, in particular a neural network using deep learning, and comprise, e.g., a CNN or RNN. The machine learning model can also comprise a plurality of concatenated neural networks that are trained together. Model parameters denote the parameters of the machine learning model whose values are modified during the training and which serve to generate an output. The training or the training process can also be called a learning process in the present context. If a training process is aborted and re-initiated with modified parameters, these successive training processes can also be understood as one learning process.

Predefined data is used for the training, said data being divided at least into training data and validation data, wherein a further part of the data is generally reserved as test data. Using the test data, a quality of the trained machine learning model is usually assessed after completion of the learning process. The division into training data and validation data does not have to be rigid; in fact, it is possible for the same data to serve once as training data and another time as validation data, as is common, for example, in cross-validation methods.

The quality measure indicates an assessment of the current output during the training, wherein the output is generated with the current model parameter values. The quality measure constitutes a metric and can indicate an improvement when a value rises or falls, depending on the selected option. If the quality measure is, e.g., a loss, an error or an error classification, then the quality measure falls with better adjusted model parameter values. If, on the other hand, the quality measure is a precision and/or accuracy, then it rises with better adjusted model parameter values, as illustrated in FIGS. 1 to 6. In supervised learning methods, the quality measure can indicate how well the output matches predetermined target data. This can be expressed by means of a loss function used in the training or, if there is a classification, in the form of a precision and/or accuracy. Precision indicates the capability of the machine learning model to name all objects that it names correctly. Accuracy, on the other hand, indicates how many objects out of a total of provided objects a classifier finds. For example, different microscope overview images in which sample carriers with a variable number of circular wells or rectangular chambers are visible can be used as training data. If the machine learning model does not find all wells in the test images, but invariably labels them correctly as wells and never as chambers, its precision is 100% while its accuracy is lower than 100%. Further possible metrics besides precision (fraction of true results/true positive results out of all positive results) and accuracy (ratio of true results to the total number of cases) when using classification models are, e.g.: recall (fraction of true results out of the sum of true results and false negative results); F1 score (weighted average of precision and accuracy) or the AUC or ROC value (the area under curve (AUC) shows the true positive rate and the false positive rate in relation to one another). When a regression model is used, a quality measure can be determined based on, e.g., one of the following metrics: mean absolute error (wherein in particular an average value of the absolute values is calculated from the deviations between each result of the model with the current model parameter values and a corresponding labelling of the input training data) or a root mean squared error, a relative absolute error, a relative squared error or the coefficient of determination or R squared (which quantifies the predictive power of the model). The quality measure can be a combination of a plurality of measures, for example a combination of precision and accuracy. Alternatively, the quality measure can also comprise different measures in parallel, e.g. precision and accuracy. In such cases, instead of a single training learning progression and a single validation learning progression, it is also possible to use a plurality of training learning progressions and validation learning progressions, which are based on precision and accuracy in the example just mentioned. The present descriptions relating to a training learning progression and a validation learning progression are intended to be understood in the sense that at least one training learning progression and at least one validation learning progression are evaluated by the verification model.

The machine learning model can also be an ensemble model in which a plurality of single models are combined. The at least one training learning progression and at least one validation learning progression can relate to the ensemble model as a whole, in particular when the ensemble model is formed by stacking, wherein a plurality of different models are joined together to form a metamodel that combines the outputs of the single models. Alternatively, respective training/validation learning progressions can be captured for each single machine learning model contained in the ensemble model and verified separately according to the invention. In this variant, the assessment of the training/validation learning progressions of the single models helps to select the best single models from a plurality of possible single models, said best single models ultimately being included in the ensemble model. If the ensemble model is formed by voting, wherein weighted averages of the results of the single models are combined, then the weighting can occur based on a respective quality assessment determined by a respective pair of training/validation learning progressions.

The training learning progression can generally be understood to be a concatenation of quality measures determined in the course of a training process (learning process) based on the training data. It is not necessary to capture a quality measure for each iterative pass; it is also sufficient when this occurs sporadically. If the training data is divided into batches for which an output is computed sequentially, the quality measure can relate to single batches or to a combination of a plurality of/all batches. A form of representation of the training progression is, as already mentioned, not critical and can be implemented in particular as a sequence of numbers or as a graphic representation. The same applies to the validation learning progression. It is also possible with the described uses of a training learning progression and a validation learning progression to capture and take into account further learning progressions. For example, two or more quality measures using different classification metrics can be captured, as explained in the foregoing. A quality measure can also be calculated from a plurality of metrics, for example an average value of two or more metrics. It is in principle also possible to combine the training learning progression and validation learning progression into a single quality measure progression. An evaluation of a single learning progression or training learning progression in the described manner can thus already yield advantages of the invention. Further variant embodiments of the invention thus result when the described training/validation learning progressions are replaced by at least one training learning progression or validation learning progression determined based on the training data or based on validation data.

The quality assessment can comprise a discrete or categorical classification, for example into two or more categories that differentiate a good training progression from a poor one. Alternatively, the quality assessment can be a (continuous) specification within a range of values or comprise qualitative statements regarding an identified type of problem, for example: unsuitable learning rate, overfitting or underfitting of model parameter values, training data or validation data is not representative, etc. The quality assessment can be displayed to a user and/or be further utilized in an automated manner.

A model (verification model, machine learning model) can be understood to be a computer program or algorithm. In the case of a machine learning model, a given model can determine the architecture of the machine learning model, which defines in particular how model parameters are used mathematically. Values of the model parameters are only determined with the training.

Further processing steps can be added in principle at any point of the described method flows. Described data can thus be replaced with data that has been further processed. For example, the training/validation learning progressions can be processed before being input into the verification model, for example by means of a standardization of values, a conversion of the data into a frequency domain or by processing with a feature extractor.

The training system of the microscopy system can be configured to carry out the different described method variants. In particular, the training system can comprise corresponding software and be constituted in principle by any computing device, for example a computer, a server, a cloud-based computing system or one or more microprocessors or graphic processors. The training system can be spatially separate from the microscope and transmit the ready-trained model to the microscope after completion of the training of the machine learning model, in particular to a computing device of the microscope. The verification model is not used or run by the microscope. In principle, the training system and the computing device of the microscope can also be formed by the same computer(s), server(s) or processor(s). The computing device of the microscope can be coupled to other microscope components and can serve, for example, to control the microscope camera and/or image acquisition and have access to an image storage system of the microscope. The training system can be launched by a microscope user, in particular at the site of the microscope. The described processing steps of the training system can be carried out either locally by a computer at the microscope or in a cloud-based manner by a remote computing system. The training system thus monitors a training of a machine learning model launched by the microscope user, which provides a form of quality control.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIGS. 1, 2, 3, 4, 5 and 6 respectively show a training learning curve and a validation learning curve of a machine learning model;

FIG. 7 shows a learning process to be monitored of a machine learning model;

FIG. 8 shows a training process of a verification machine learning model of an example embodiment according to the invention;

FIG. 9 shows a flowchart of an example embodiment of a method of the invention; and

FIG. 10 shows an example embodiment of a microscopy system of the invention.

### DETAILED DESCRIPTION OF EXAMPLE EMBODIMENTS

Different example embodiments are described in the following with reference to the figures.

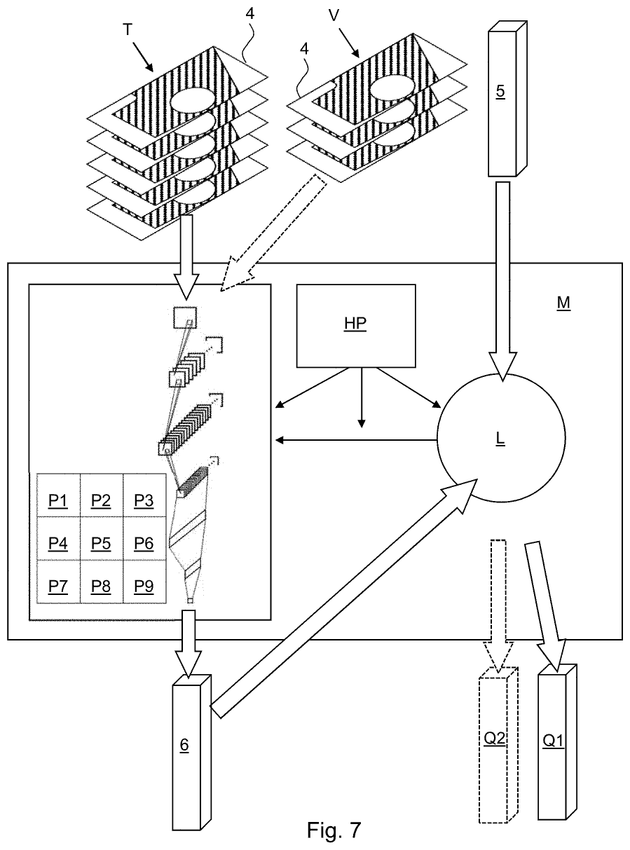

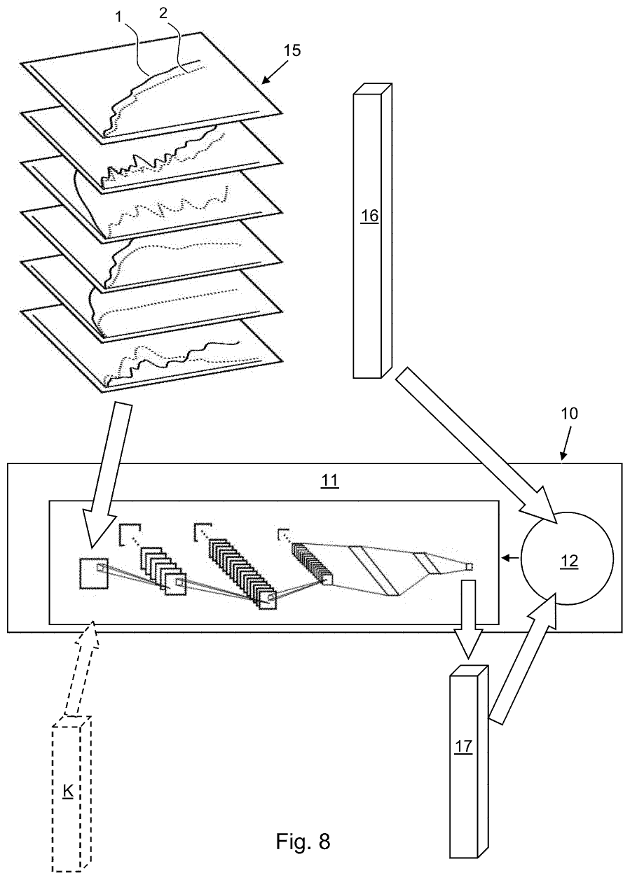

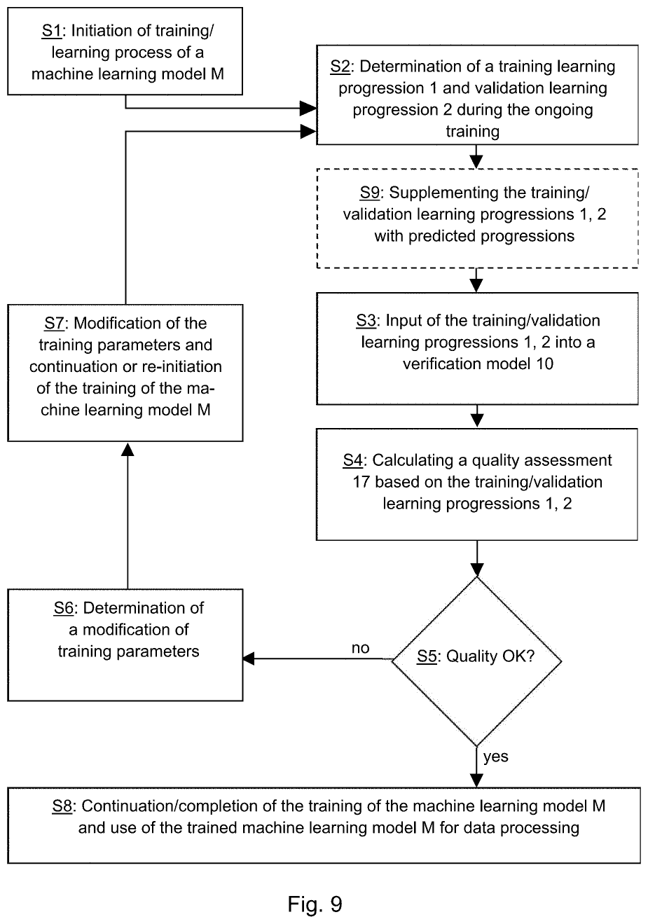

The detailed description begins with an explanation of general characteristics of a learning process of a machine learning model with reference to FIG. 7. Such a learning process is verified according to the invention, to which end a verification model is used. An example verification model that uses its own machine learning model to verify the learning process of said first machine learning model is subsequently described with reference to FIG. 8. The individual steps of the verification process and possible follow-up actions are described with reference to FIG. 9.

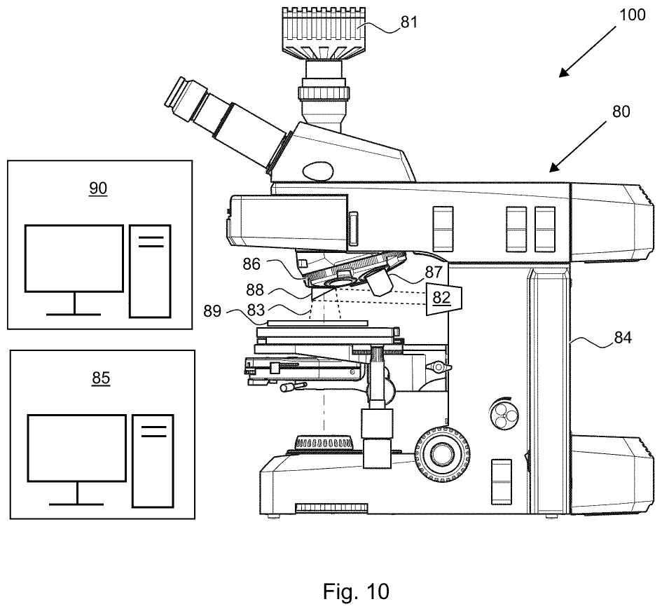

A microscopy system using the aforementioned means is finally described with reference to FIG. 10.

### FIG. 7

FIG. 7 illustrates schematically operations of a learning process of a machine learning model M. The machine learning model M comprises different model parameters P1-P9 whose values are to be defined during the training/learning process. This is accomplished using training data T. The training data T in this example are a plurality of microscope images 4, which can already have been processed and do not have to be raw images captured by a microscope. For the processing of these training images, the machine learning model in the illustrated example comprises a convolutional neural network. The model parameters P1-P9 here comprise entries of convolution matrices/filter kernels, wherein the number of model parameters P1-P9 depends on the model and in no way is to be limited by the illustrated example to a given number. In other embodiments, the machine learning model M can have a different structure and/or the training data T can be other images or other data, for example videos, audio signals, numerical data or texts.

The depicted example illustrates a supervised learning process in which labels/target data 5 are specified for the training data T. With the training data T as input, the machine learning model M computes an output 6 using the current model parameter values P1-P9. A difference between the output 6 and the target data 5 is captured by a loss function L. Based on an output of the loss function L, the model parameter values P1-P9 are modified in order to minimize the loss function L iteratively. While the model parameter values P1-P9 are used for computing the output 6, the machine learning model M comprises further parameters (hyperparameters HP) that are not taken into account in the calculation of the output 6. The hyperparameters HP can comprise, e.g., a learning rate, which indicates a magnitude by which model parameter values P1-P9 are modified depending on a result of the loss function L. Instead of the loss function L, it is also possible to optimize, in particular minimize or maximize, another function with the output 6 and the target data 5 as inputs, for example a reward function. An iterative pass in which an output 6, a result of the loss function L and a modification of the model parameter values P1-P9 are computed can be called an epoch. A stopping criterion with which the learning process is ended can be specified, for example when a minimum of the loss function L is reached or a predetermined number of epochs is reached.

A quality measure Q1 is captured in each epoch, the quality measure Q1 being a measure of the extent to which an output 6 generated with the current model parameter values P1-P9 from the training data T matches the target data 5. For example, the machine learning model M can calculate a sample stage height for each microscope image 4 of the training data T by means of regression analysis. The target data 5 in this case indicates the known sample stage height. The quality measure Q1 indicates in this example how well the sample stage height calculated by the model matches the actual sample stage height, whereby the quality measure Q1 can be, e.g., a difference in height.

In addition to the training data T, validation data V is also used, which is derived from the same data set as the training data T and which likewise consists of microscope images 4 in this example. The target data 5 comprises respective target values for the training data T and validation data V. An output 6 is also computed from the validation data V in each epoch, the output 6 being compared with the corresponding target data 5 in order to determine a quality measure Q2. The quality measure Q2 is a measure of the extent to which the output 6 generated with the current model parameter values P1-P9 from the validation data V matches the corresponding target data 5.

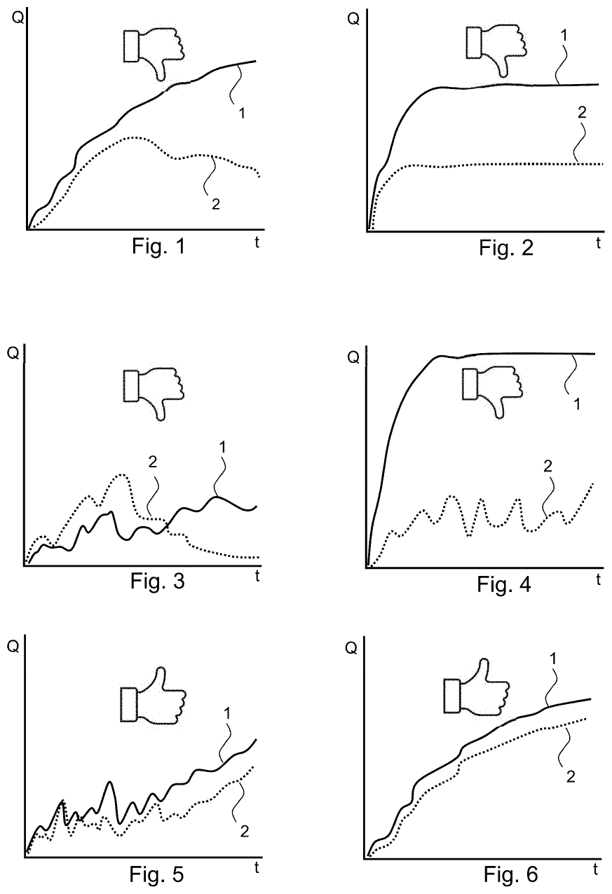

The quality measures Q1 and Q2 are captured over a plurality of epochs and a training learning progression and a validation learning progression are formed from the same, as illustrated, for example, in FIGS. 1-6 and described in the introduction.

Although FIG. 7 shows a supervised learning process, it is also possible to conduct an unsupervised learning process in variants of this embodiment. In this case, there is no specification of target data 5 and it is not necessary to provide validation data V either. The machine learning model M then generates an output from each microscope image 4 of the training data T and a clustering/segmentation into clusters is determined from these outputs. A quality measure Q1 or Q2 can then indicate, e.g., how many outputs are assigned to each cluster, how large a separation between clusters is or how closely outputs within a cluster are bundled. Possible metrics here quantify, for example, an aggregate deviation of the respective outputs from the next cluster centroid, e.g. as an average distance from the next cluster centre, or an average distance from other cluster centres. Such quality measures logged over the course of a learning process can also form a training/validation learning progression like the ones illustrated in FIGS. 1-6.

In a variant of the embodiment of FIG. 7 for a machine learning model with a generative adversarial network (GAN), the validation data V and a labelling in the form of the target data 5 can be omitted. The training data T is fed to the discriminator of the GAN, while the generator receives, e.g., random values or noise as inputs. It is possible to use a plurality of loss functions L.

### FIG. 8

FIG. 8 illustrates a training process of a verification machine learning model 11. The verification machine learning model 11 is an example of a verification model 10 and is trained to generate a quality assessment 17 as an output from an input comprising a training learning progression 1 and a validation learning progression 2 or derived from the same. The quality assessment 17 makes a statement regarding the learning process of the machine learning model M described in relation to FIG. 7. Training data 15 thus comprises a plurality of pairs of training/validation learning progressions 1, 2 with respectively associated target data 16. Parameters of the verification machine learning model 11 are adjusted with the help of a loss function 12 in such a manner that the output quality assessment 17 ideally matches the target data 16. The target data 16 can be manually specified and indicate, for example, a categorical division, which is intimated in FIGS. 1-4 as a poor learning process and in FIGS. 5-6 as a good learning process.

In the example of FIG. 8, the training data 15 is provided as image data showing the curves of the training/validation learning progressions 1, 2 graphically. The verification machine learning model 11 is formed as a convolutional neural network. Alternatively, it is also possible to use another architecture for the verification machine learning model 11 and/or another form of data for the training data 15. For example, the verification machine learning model 11 can be formed as an RNN while the training/validation learning progressions 1, 2 can be respectively formed by a sequence of numbers (time series).

The training data 15 comprises training/validation learning progressions 1, 2 generated with machine learning models M of different designs and/or with different sets of training data T for the same machine learning model M and/or with different hyperparameters HP for the same machine learning model M. The training data 15 thereby covers a large spectrum of different cases. For example, the different machine learning models M can respectively be CNNs and differ in the number and size of convolutional layers or the type of activation or pooling layers. In the case of different hyperparameters, it is also possible for one and the same neural network to have been trained a plurality of times (in particular with the same training data) using different learning rates, regularizations of the objective/loss function or divisions into training and validation data.

Hyperparameters and further information regarding the architecture of the machine learning model M can optionally be used as contextual data K together with the training data 15 in the training of the verification machine learning model 11.

The quality assessment 17 can be a categorical assessment, as illustrated in FIGS. 1-6 by symbols for good and poor learning processes. Alternatively, the quality assessment 17 can also be a specification in a value range or include an instruction to intervene in the learning process. This is described in greater detail in the following with reference to FIG. 9.

### FIG. 9

FIG. 9 shows a flowchart with method steps for the verification of the learning process of the machine learning model M of FIG. 7 by means of the ready-trained verification machine learning model of FIG. 8.

In step S1, a learning process, i.e. a training, of the machine learning model M is launched.

In step S2, a training learning progression 1 and a validation learning progression 2 as illustrated in any of FIGS. 1 to 6 are determined. Step S2 is carried out already during the ongoing training, i.e. before a stopping criterion for ending the learning process has been reached.

In step S3, the training/validation learning progressions 1, 2 are fed to the verification machine learning model 11 of FIG. 8, or more generally to the verification model 10.

The verification model 10 then computes in step S4 a quality assessment 17 from the training/validation learning progressions 1, 2.

In step S5, it is verified whether the quality assessment 17 indicates an adequate quality. If this is not the case, step S6 follows.

In step S6, a modification of training parameters is determined. The training parameters can be hyperparameters or model parameters of the machine learning model M. The determination of this modification is effected with the verification machine learning model 11 in some variant embodiments. In this case, the target data 17 used in the training of the verification machine learning model 11 also includes modifications of training parameters to be performed, as specified, for example, manually by a machine learning expert. If the modification generated in step S6 is a modification of model parameters of the machine learning model M, then the verification machine learning model 11 of FIG. 8 was trained for this purpose with training data 15 comprising not only training/validation learning progressions 1, 2, but also the respectively associated model parameter values P1-P9.

Step S6 is followed by S7, in which the modification of the training parameters is effected. The training of the machine learning model is then continued or re-initiated with the modified training parameters. If the process is continued, then the training parameters can be modified, for example the maximum number of epochs after which at the latest the training is ended can be increased. Alternatively, a modification may be that the learning rate is temporarily increased in order to break out of a local optimum of the model parameter values.

After step S7, a plurality of training epochs of the machine learning model M are conducted. Training/validation learning progressions are respectively captured in the process and the steps as of step S2 repeated. This loop is repeated until it is established in step S5 that the quality assessment 17 indicates an adequate quality. Step S8 then follows, in which the training is ended, i.e. the learning process is continued until a stopping criterion is reached. The machine model M is now successfully trained and can be used for its intended purpose. In the example of FIG. 7, this is the evaluation of a microscope image 4.

Simple known verification methods only evaluate a machine learning model once the stopping criterion has been reached. In the case of automated evaluations, there merely occurs a verification with the final model parameter values using test data, i.e. an assessment of the final quality measures at the reaching of the stopping criterion. The progression of the quality measures is not taken into account. Moreover, a machine learning expert is conventionally required for a qualitative evaluation of the progression. In contrast, the verification machine learning model 11 allows potentially more reliable results, while laborious and cost-intensive interventions of a data scientist are needed less frequently or not required at all. A further advantage is that the quality assessment and possible intervention of steps S5 to S7 can occur already during the ongoing training process. Advantages over the prior art are, however, also achieved when step S2 and the following steps are not performed until a stopping criterion of the machine learning model M has been reached. In S7, it is possible to use advantageous modifications for a re-initiation of the training process.

Optionally, a step S9 can be added, in particular between S2 and S3. In step S9, a prediction is made regarding the further progression of the training/validation learning progressions 1, 2 based on the training/validation learning progressions 1, 2 up to that point. This can occur in particular with a machine learning model (prediction machine learning model) trained for this purpose. The prediction machine learning model receives a first section of training/validation learning progressions 1, 2 as training data, for example respectively the beginning of the progression curves illustrated in FIGS. 1 to 6. As target data, the prediction machine learning model receives the complete training/validation learning progressions 1, 2 or a section of the training/validation learning progressions 1, 2 immediately following the first section, for example respectively the ends of the curves illustrated in FIGS. 1 to 6. Optionally, the hyperparameters or model parameter values used can also be used as input data in the training of the prediction machine learning model. This allows the prediction machine learning model to predict a training/validation learning progression 1, 2 particularly early in the learning process, i.e. to generate the corresponding data. This data is then used in step S3. The quality assessment thus occurs on the basis of training/validation learning progressions 1, 2 that partially comprise predicted values. Alternatively or additionally, a prediction machine learning model can also be useful between other steps described here and in particular inform a decision whether to continue a learning process or re-initiate the same with modified values.

In variants of the illustrated embodiment, the steps S6 and S7 are omitted and, instead, an output from step S4 or S5 is displayed to a user. The user can then decide based on the quality assessment 17 whether it is expedient to intervene or how to intervene in the learning process. In particular in variants in which a GAN is trained, it is possible to omit the validation learning progression 2. In further variants of the illustrated example, one or more training learning progressions 1 and/or one or more validation learning progressions 2 are used.

### FIG. 10

FIG. 10 shows an example embodiment of a microscopy system 100 of the invention. The microscopy system 100 comprises a microscope 80 with at least one camera 81, 82, a stand 84, a computing device 85 and an objective 87. In the illustrated example, the microscope 80 comprises an objective revolver 86 by means of which the objective 87 or another objective can be placed in the light path. If the objective 87 is located in the light path, detection light can be guided via the objective 87 to the camera 81, which can also be called the sample camera. The camera 82, on the other hand, serves to capture an overview image and can be called the overview camera. In the illustrated example embodiment, the camera 82, the field of view 83 of which is depicted by means of dashed lines, views a sample carrier 89 via a deflection mirror 88. The deflection mirror 88 is arranged on the objective revolver 86 and can be optionally selected instead of the objective 87. It is also possible to use another deflection element instead of the deflection mirror 88. Variants in which the camera 82 views the sample carrier 89 directly, with no deflection, are also possible. An overview image of the camera 82 or a sample image of the camera 81 can constitute a microscope image which forms the input for the machine learning model described with reference to FIG. 7.

The computing device 50 can in particular be configured to receive captured microscope images and optionally to control an image acquisition by the microscope.

The microscopy system 100 further comprises a training system 90. This can be formed, for example, by one or more computers, GPUs or other processors. The training system 90 receives microscope images from the computing device 50 and is configured to conduct the supervised training of the machine learning model M described with reference to FIGS. 7 to 9.

The ready-trained machine learning model M can be transmitted by the training system 90 to the computing device 50 or to computing devices of a plurality of other microscopes. Thereafter, when a microscope image is captured, the computing device 50 can carry out a processing of the microscope image using the trained machine learning model M. The trained machine learning model M thus forms part of an imaging processing program run by the computing device 50.

The computing device 50 can be located at or close to the respective microscope 80 while the training system 90 can be arranged spatially independently from the same at a remote site. In principle, the training system 90 and the computing device 50 can also be directly connected to one another or be formed by the same components, for example the same computer(s).

The described example embodiments are purely illustrative and variants of the same are possible within the scope of the attached claims.

### LIST OF REFERENCE SIGNS

1 Training learning progression of a learning process of the machine learning model M
2 Validation learning progression of a learning process of the machine learning model M
4 Microscope image
5 Target data of a supervised learning process of the machine learning model M
6 Output data of the machine learning model M
10 Verification model
11 Verification machine learning model
12 Loss function of the verification machine learning model 11
15 Training data of the verification machine learning model 11
16 Target data (predetermined quality assessments for the training/validation learning progressions 1 and 2)
17 Quality assessment calculated by the verification model 10
80 Microscope
81, 82 Camera
83 Field of view of the camera 82
84 Stand
85 Computing device
86 Objective revolver
87 Objective
88 Deflection mirror
89 Sample carrier
90 Training system
100 Microscopy system
P1-P9 Model parameters
HP Hyperparameters
K Contextual data
L Loss function for the training of the machine learning model M
M Machine learning model
Q1 Quality measure based on the training data T
Q2 Quality measure based on the validation data V
S1-S9 Steps of an example embodiment of the method of the invention
t Time/experience/number of epochs
T Training data of the machine learning model M
V Validation data of the machine learning model M

What is claimed is:

1. A microscopy system
with at least one microscope, which comprises at least one camera for capturing a microscope image and a computing device, wherein the computing device comprises an imaging processing program for processing the microscope image by means of a machine learning model; and
with a training system for carrying out a learning process of the machine learning model, wherein model parameter values of the machine learning model are adjusted in the learning process using training data, wherein during the learning process a quality measure based on the training data and a quality measure based on validation data are calculated for current model parameter values and a training learning progression and a validation learning progression are formed from the quality measures;
wherein the training system comprises a verification model, which is fed with the training learning progression and the validation learning progression during the learning process; and
wherein the verification model is configured to generate a quality assessment of the learning process of the machine learning model depending on the training learning progression and the validation learning progression.

2. A method for monitoring a learning process of a machine learning model, comprising
launching a learning process using training data in order to adjust model parameter values of the machine learning model;
wherein during the learning process a quality measure based on the training data and a quality measure based on validation data are calculated for current model parameter values and a training learning progression and a validation learning progression are formed from the quality measures,
wherein the training learning progression and the validation learning progression are fed to a verification model during the learning process; and
wherein the verification model generates a quality assessment of the learning process of the machine learning model depending on the training learning progression and the validation learning progression.

3. The method as defined in claim 2,
wherein the training learning progression and the validation learning progression are fed to the verification model during an ongoing training of the machine learning model before a predetermined stopping criterion of the training is reached.

4. The method as defined in claim 3,
wherein a decision is made based on the quality assessment whether to continue or abort the ongoing training of the machine learning model.

5. The method as defined in claim 2,
wherein the verification model comprises a verification machine learning model, which is trained to generate the quality assessment as output from the training learning progression and the validation learning progression as input data.

6. The method as defined in claim 5,
wherein the verification machine learning model is trained by an unsupervised learning process, in which a plurality of training learning progressions and associated validation learning progressions are used as verification machine learning model training data, or
wherein the verification machine learning model is trained by a supervised learning process, in which a plurality of training learning progressions and associated validation learning progressions with a predetermined quality assessment are used as verification machine learning model training data.

7. The method as defined in claim 5,
wherein the training learning progression and the validation learning progression are respectively fed to the verification machine learning model as a sequence of quality measure values; and
wherein the verification machine learning model comprises a recurrent neural network.

8. The method as defined in claim 5,
wherein the training learning progression and the validation learning progression are fed to the verification machine learning model as graphs in the form of image data; and
wherein the verification machine learning model comprises a convolutional neural network.

9. The method as defined in claim 2,
wherein the verification model takes one or more of the following factors into account for the quality assessment:
jumps in the training learning progression or validation learning progression;
number of epochs after which the training learning progression or validation learning progression saturates, and a value of the quality measures during saturation;
difference between the training learning progression and the validation learning progression;
divergence of the training learning progression or validation learning progression;
initial fluctuations in the training learning progression and validation learning progression and subsequent monotonous training learning progression and validation learning progression;
whether an optimum of the model parameter values at which a quality measure is below a predetermined limit value is reached early.

10. The method as defined in claim 2,
wherein the quality assessment comprises a suggestion for a modification of training parameters during the ongoing learning process or for a new learning process to be initiated.

11. The method as defined in claim 10,
wherein the modification of training parameters comprises at least one of: a modification of a learning rate and a modification of a set number of epochs.

12. The method as defined in claim 10,
wherein, in the event that the quality assessment assumes a local optimum of the model parameter values, the modification of training parameters comprises a one-time or repeated increase of a learning rate in order to escape the local optimum of the model parameter values.

13. The method as defined in claim 10,
wherein the modification of training parameters comprises a modification of the model parameter values;
wherein the verification machine learning model also receives to this end, in addition to the training learning progression and the validation learning progression, associated model parameter values of the machine learning model as inputs.

14. The method as defined in claim 13,
wherein the verification machine learning model comprises a neural network trained by a supervised learning process, in which training data comprises a plurality of training learning progressions, validation learning progressions and associated model parameter values, as well as modifications of the model parameter values as target data; or
wherein the verification machine learning model comprises a neural network trained by a reinforcement learning method, in which a reinforcement learning agent learns using a predefined training environment, for an input comprising a training learning progression, a validation learning progression and associated model parameter values, how to modify the model parameter values in order to optimize the quality assessment.

15. The method as defined in claim 2,
wherein the training learning progression and the validation learning progression are input into a prediction machine learning model that is trained to predict future progressions of an input training learning progression and validation learning progression from the input training learning progression and validation learning progression and to add the predicted future progressions onto the input training learning progression and validation learning progression,
wherein the training learning progression and validation learning progression supplemented by the prediction are output to a user or to the verification model.

16. The method as defined in claim 2,
wherein the verification machine learning model is configured to conduct an anomaly detection in order to determine deviations from typical training progressions,
wherein the verification machine learning model for the anomaly detection is designed as an autoencoder trained with training learning progressions and validation learning progressions that do not contain any anomalies.

17. The method as defined in claim 2,
wherein the verification model is designed to define assessment criteria for the generation of the quality assessment depending on contextual data, wherein the contextual data relate to the machine learning model or the training of the machine learning model,
wherein the contextual data comprise information regarding one or more of the following aspects:
type of a learning method, wherein a distinction is made at least between supervised training, unsupervised training, reinforcement learning and a use of adversarial networks;
type of a task of the machine learning model, wherein a distinction is made at least between a classification, segmentation, detection or regression;
architecture of the machine learning model;
values of hyperparameters of the machine learning model;
a type of the training/validation data.

18. A computer program with commands that, when executed by a computer, cause the execution of the method defined in claim 2.

19. A method for monitoring a learning process of a machine learning model containing a generative adversarial network, comprising
launching a learning process using training data in order to adjust model parameter values of the machine learning model;
wherein during the learning process at least one quality measure is calculated for respectively current model parameter values and at least one training learning progression is formed from the quality measures;
wherein the at least one training learning progression is fed to a verification model during the learning process; and
wherein the verification model generates a quality assessment of the learning process of the machine learning model depending on the at least one training learning progression.
